(19) United States
(12) Patent Application Publication
(10) Pub. No.: US 2010/0076680 A1
(43) Pub. Date: Mar. 25, 2010

(54) VEHICLE NAVIGATION SYSTEM WITH INTERSECTION DATABASE

(75) Inventors: Sadanori Horiguchi, Novi, MI (US); Deepak Ramaswamy, Superior Township, MI (US)

Correspondence Address: GIFFORD, KRASS, SPRINKLE,ANDERSON & CITKOWSKI, P.C, PO BOX 7021, TROY, MI, 48007-7021, US

(73) Assignee: Xanavi Informatics Corporation, Kanagawa-Ken (JP)

(21) Appl. No.: 12/236,814

(22) Filed: Sep. 24, 2008

(51) Int. Cl. G01C 21/34

(52) U.S. Cl. 701/209

(57) ABSTRACT

A vehicle navigation system having a processor having access to a map database. An input device enters the destination to the processor and the processor, using data from the map database, calculates a preferred route to the destination. That preferred route is then displayed on a video display. The map database includes a road link database as well as an intersection database which is separate from the road link database which enables a destination to be entered to the input device by an intersection.

### BACKGROUND OF THE INVENTION

I. Field of the Invention

The present invention relates generally to vehicle navigation systems and, more particularly, to such a navigation system having an intersection database.

II. Description of Related Art

Navigation systems for automotive vehicles have enjoyed increasing popularity in recent times. These previously known navigation systems typically include a display device, such as an LCD screen, which displays map and road information to the driver or other occupants of the vehicle.

Many previously known vehicle navigation systems enable the user to input a destination by the address of the desired destination. Once inputted to the navigation system, the navigation system then calculates a preferred route, typically the fastest route, between the current position of the vehicle and the destination.

In many situations, however, the actual street address for the destination is unknown to the operator of the automotive vehicle. Instead, the operator of the automotive vehicle knows the intersection of the desired destination, but not the address of the desired destination at that intersection. As such, for many of the previously known navigation systems it has been difficult, if not impossible, to input the destination to the navigation system or to have the navigation system calculate the preferred route to that destination.

There have, however, been previously known navigation systems which allow the user to input an intersection as a desired destination. These previously known systems, however, have not proven wholly satisfactory in operation.

In particular, these previously known navigation systems which allow the user to input an intersection as the desired destination typically use the map database containing road link data to identify the intersection based upon that road link data and the actual position by latitude and longitude of the various intersections along that road link data. These systems, however, have not proven wholly satisfactory in operation.

One disadvantage of these previously known systems is that such systems fail to account for intersections in which one road link terminates at a midpoint of another road link. Similarly, these previously known navigation systems have been unable to account for the intersections of roads which are vertically separated from each other, e.g. a bridge, elevated ramp or similar roadway.

A still further disadvantage of these previously known navigation systems is that it is computationally time consuming to identify intersections from road link data based upon the latitude and longitude of those road links. As such, such navigation systems may appear to be sluggish in operation and/or require more expensive processors.

### SUMMARY OF THE PRESENT INVENTION

The present invention provides a navigation system which overcomes all of the above-mentioned disadvantages of the previously known navigation systems.

In brief, the vehicle navigation system of the present invention comprises a processor having access to a map database. An input device, such as a touch screen on a display device, is used to enter a destination by intersection, as well as by street address, to the processor. Unlike the previously known navigation systems, however, the map database contains both a road link database typical in navigation systems as well as an intersection database which is separate from the road link database.

Consequently, when an intersection is inputted to the navigation system by the input device in which the destination comprises an intersection rather than a street address, the processor utilizes the intersection database and the map database to identify the desired destination and, thereafter, a preferred route to that destination from the current position of the vehicle using standard routing algorithms.

In a preferred embodiment of the invention, the navigation system maintains a first cache of intersection data within a predefined area surrounding the home position of the automotive vehicle and thus of the navigation system. As a practical matter, it is more likely that the operator of the navigation system will enter an intersection as the desired destination in the area surrounding the home location for the navigation system as opposed to a more remote intersection. Consequently, the cache enables rapid identification of a nearby intersection for use by the processor in computing the preferred route to that destination.

Similarly, a second cache is also preferably provided which maintains intersection data within a predefined area surrounding the current position of the automotive vehicle. The second cache is routinely updated whenever the automotive vehicle moves a predetermined distance. As such, the intersection data within a predefined area surrounding the current position of the automotive vehicle is rapidly available to the processor and the navigation system to compute the desired route to that destination.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a block diagrammatic view illustrating a preferred embodiment of the present invention;

FIG. 2 is a block view illustrating the map database;

FIG. 3 illustrates an exemplary data format for the road link database;

FIG. 4 illustrates an exemplary data format for the point of interest database;

FIG. 5 is an exemplary format for the intersection database;

FIG. 6 is a block diagrammatic view illustrating the operation of the intersection database together with memory caches;

FIG. 7 is a flowchart illustrating the operation of the intersection database and caches;

FIG. 8 is a block diagrammatic view illustrating a portion of the keyword database and the parsing of input queries;

FIG. 9 is a flowchart illustrating the operation of the present invention; and

FIG. 10 is a view illustrating the basis for the road link database.

### DETAILED DESCRIPTION OF A PREFERRED EMBODIMENT OF THE PRESENT INVENTION

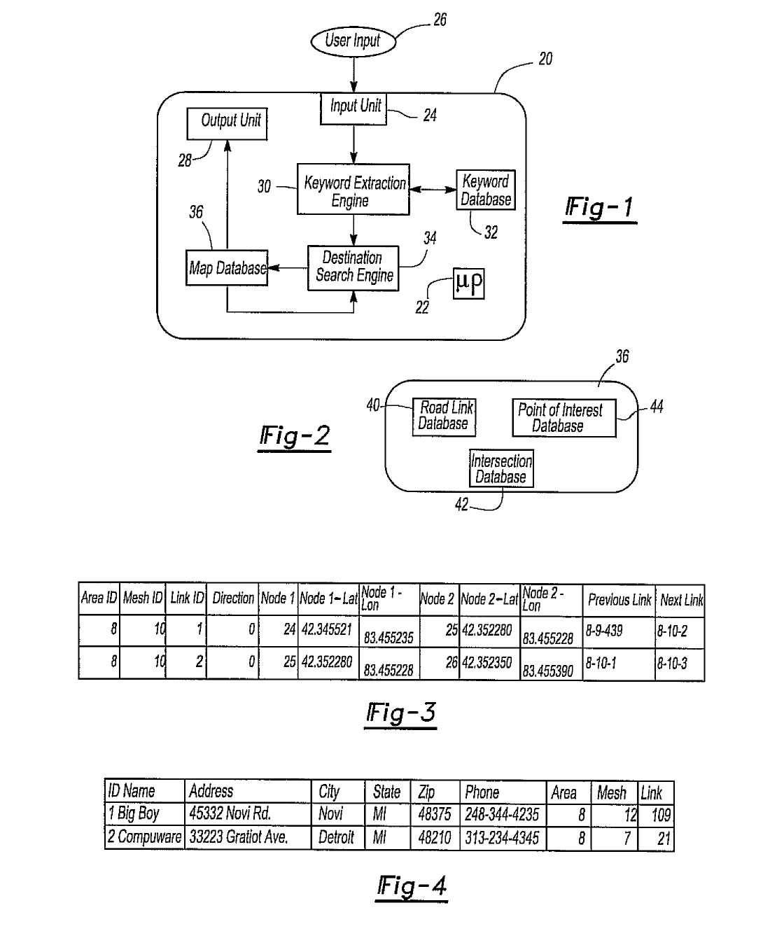

With reference first to FIG. 1, a block diagrammatic view of a navigation system 20 according to the present invention is illustrated. The navigation system 20 operates under the control of a processor 22 and includes an input device 24 which inputs the desired destination from a user 26. The input device 24 may be of any conventional construction and can, for example, comprise a voice recognition unit. Alternatively, the input device may be a key pad, such as touch screen on a display device 28, a mouse, joystick or the like.

The input device 24 provides its output to a keyword extraction engine 30 having access to a keyword database 32. For example, if the input device 24 comprises a voice recognition input device, the keyword extraction engine would look for keywords such as “go to” or “and”, both of which are in the keyword database 32. For example, the instruction “go to Main and Maple” would result in the keyword extraction engine extracting the road links “Main” and “Maple” while the keyword “and” between the two road names serves as a separator for those road names. The keyword “go to” would be recognized by the keyword extraction engine 30 as the desired destination for the vehicle. A keyword algorithm is subsequently described in greater detail.

The output from the keyword extraction engine 30 is provided as an input to a destination search engine 34. The search engine 34, under control of the processor 22, searches a map database 36 for the desired destination. Once found, the processor 22 displays the destination, as well as a preferred route from the current position of the vehicle to that destination, on the display device 28.

With reference now to FIG. 2, the map database 36 includes a road link database 40 as well as an intersection database 42 separate from the road link database 40. The map database 36 also optionally includes a point of interest database 44. The formats of the three databases 40, 42 and 44, however, differ from each other.

With reference now to FIG. 10, the road link database 40 contains road link data. In the conventional fashion the geographical area covered by the navigation system is directed into a number of different areas 150 and each area 150 is then subdivided into a number of meshes 152. The various road links 154 for each mesh 152 in each area 150 are then identified by a unique ID number. Consequently, each road link in the database 40 may be uniquely identified by the area ID, the mesh ID and the road link ID.

For example and with reference to FIG. 3, two exemplary road links for the road link database 40 are illustrated in FIG. 3 for road links 1 and 2 in the area ID 8 and mesh ID 10. Each road link includes a beginning node, identified by both its latitude and longitude, as well as its ending node, node 2, also identified by its latitude and longitude. The direction of the road link from node 1 to node 2 is also contained in the database as well as the previous road link and next road link data. Such a format for the road link database is well known.

With reference now to FIG. 4, the data format for the point of interest database 44 is illustrated for two points of interest, namely a Big Boy restaurant and a Compuware store. In the point of interest database 44, each point of interest is assigned not only an ID number, but also the name and address of the point of interest. The area, mesh and road link for the point of interest is also contained in the point of interest data. Consequently, by utilizing the information in the point of interest database, the actual location of the point of interest may be determined from the road link database 40.

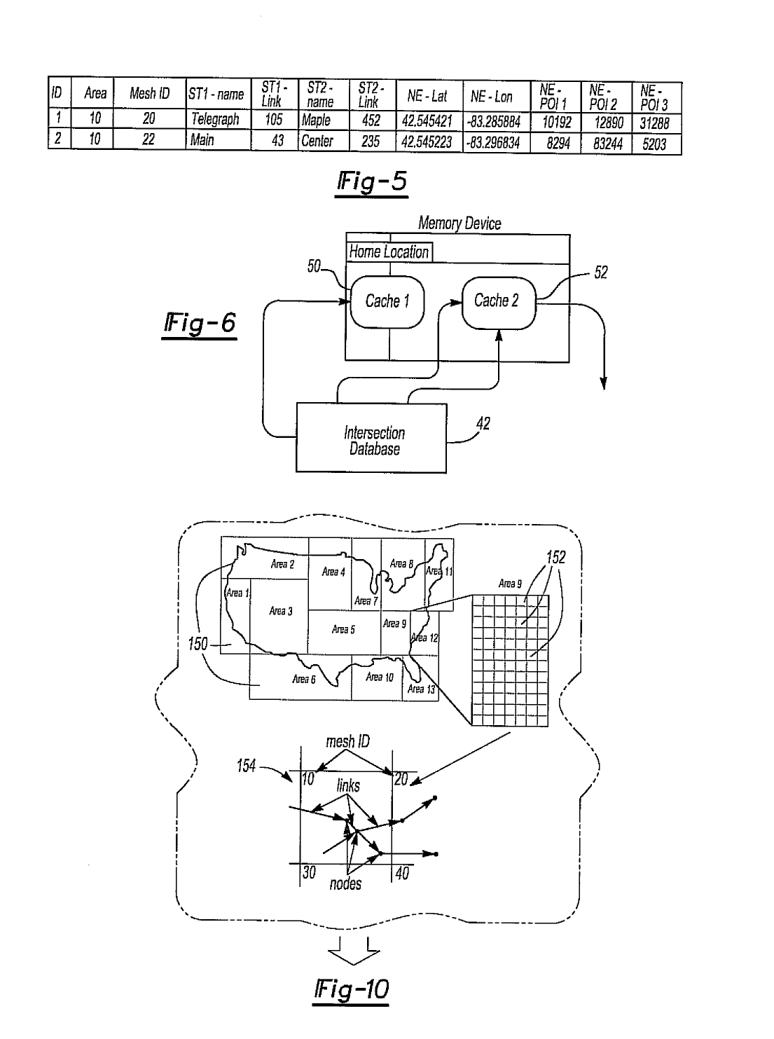

With reference now to FIG. 5, a preferred data format for the intersection database 42 is shown for two intersections. Each intersection is assigned an ID number, in the example shown in FIG. 5, the ID number 1 and 2.

The area and mesh ID of each intersection in the intersection database is also contained as well as the street names ST1 and ST2 for the road links which form the intersection. The latitude and longitude for each intersection is also contained in each entry of the intersection database.

Each intersection in the intersection database 42 may also contain one or more points of interest POI1 . . . POIn which are identified by their ID number (see FIG. 4). As shown in FIG. 5, three different points of interest are illustrated for each entry in the intersection database 42. The provision of three different points of interest, however, is by way of example only and more or fewer points of interest may be contained for each entry in the intersection database. Optionally, the point of interest could contain a pointer to a list of the points of interest data contained elsewhere in memory by the processor. In either case the actual location for the point of interest may then be determined from the point of interest database 44 using the area ID, mesh ID and point of interest ID.

As a practical matter, it is more common for the operator of a motor vehicle to identify a destination by intersection that is close to the home address of the navigation systems or, alternatively, relatively near the current position of the vehicle containing the navigation system as opposed to much more distant intersections. With reference then to FIG. 6, a first memory cache 50 is preferably provided which maintains intersection data within a predefined area surrounding the home location of the vehicle containing the navigation system. Preferably, the information in the cache 50 is maintained in persistent memory, such as flash memory, so that the intersection data for the area surrounding the home location of the vehicle containing the navigation system is available whenever the navigation system is activated or turned on.

Still referring to FIG. 6, the navigation system preferably maintains a second cache 52 containing intersection data from the intersection database 42 of intersections within a predefined area surrounding the current position of the vehicle. The intersection data contained in the second cache 52 is also preferably updated as a function of the position of the vehicle.

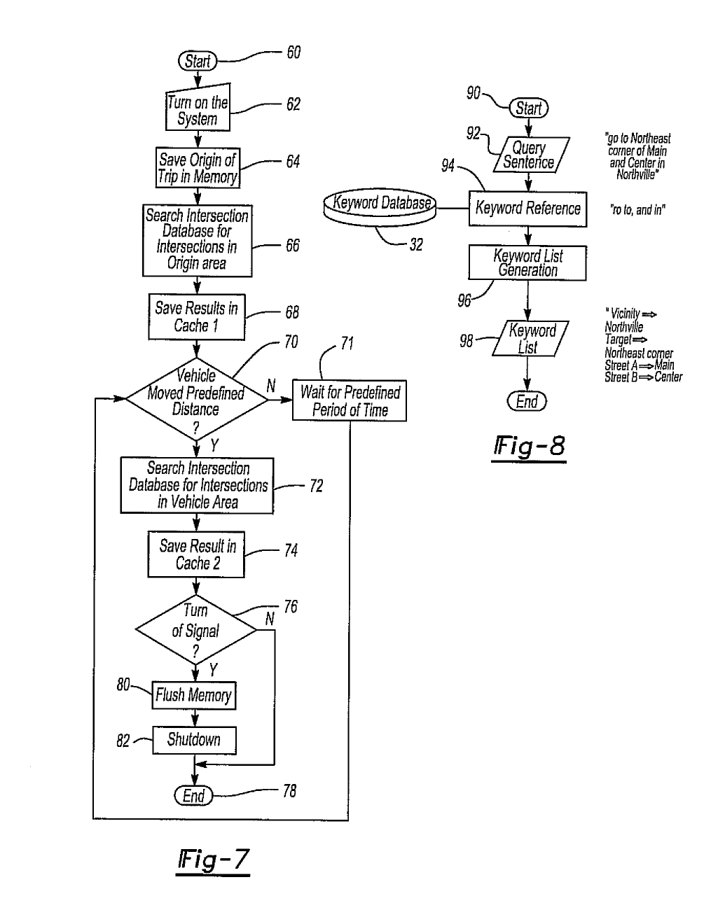

With reference now to FIG. 7, an exemplary flowchart illustrating the operation of the intersection database 42 together with the two caches 50 and 52 is shown. The routine is initiated at step 60 which then proceeds to step 62 which turns on the navigation system. Step 62 then proceeds to step 64 which saves the origin, i.e. the current position of the vehicle, in memory. Step 64 then proceeds to step 66.

At step 66, the processor searches the intersection database 42 for intersections within a predefined area surrounding the origin or home determined at step 64. Step 66 then proceeds to step 68 and saves the intersections within the predetermined area surrounding the home in the first cache 50.

Conversely, if the intersection database contained in the first cache 50 is maintained in persistent memory, steps 64-68 may be omitted.

After the intersection data is stored in the first cache 50, step 68 proceeds to step 70 which determines if the vehicle has moved a predetermined or predefined distance. If the vehicle has not moved, step 70 proceeds to step 71 which delays for a predetermined period of time and then branches back to step 70 which again determines if the vehicle has moved a predefined distance. If so, step 70 proceeds to step 72.

At step 72, the processor searches the intersection database for intersection data within a predefined area surrounding the current position of the vehicle. Step 72 then proceeds to step 74 and stores the identified intersections in the second cache 52.

Step 74 then proceeds to step 76 which determines if a turn off signal has been received by the navigation system. If not, step 76 branches to step 78 and exits the procedure. Otherwise, step 76 proceeds to step 80 which erases the intersection data from at least the second cache 52, and optionally both caches 50 and 52. Step 80 then proceeds to step 82 which shuts down the navigation system software and then to step 78 to exit the routine.

With reference now to FIG. 8, the keyword extraction engine 30 (FIG. 1) is there shown in greater detail for use with a speed activation system. After the routine is initiated at step 90, step 90 proceeds to step 92 where the query sentence for voice recognition is inputted. For example, the query sentence may be “Go to Northeast corner of Main and Center in Northville”, Step 92 then proceeds to step 94.

At step 94, under control of the processor, the keywords in the query sentence entered at step 92 are compared with the data in the keyword database 32. In this case, the keywords may include “go to”, “Northeast corner of”, “and” and “in”.

The keywords are identified at step 96 which then proceeds to step 98 which creates a list of the keywords. In doing so, not only are the keywords, but also the street names of the intersection also identified. Step 98 then proceeds to step 100 where the procedure is terminated.

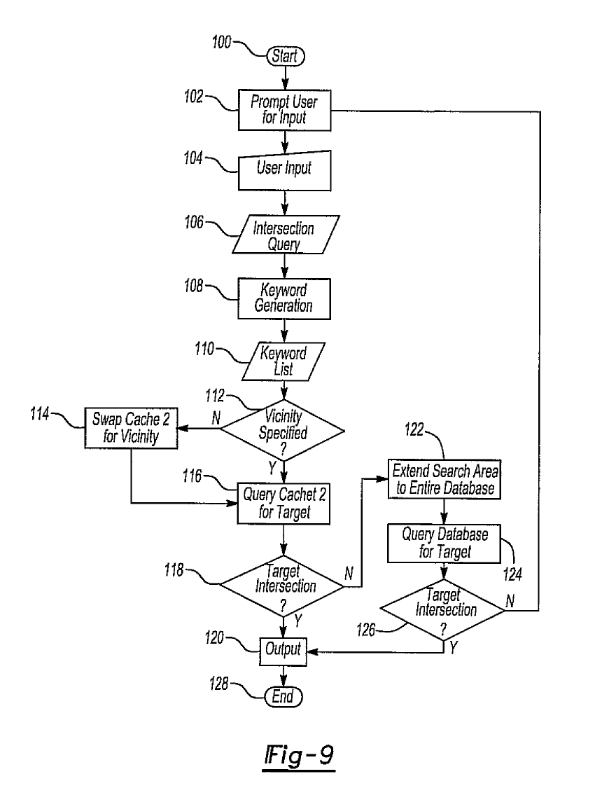

With reference now to FIG. 9, an overall flow process chart for the operation of the navigation system of the present invention is shown. The process starts at step 100 which then proceeds to step 102 which prompts the user to input the intersection data. The user then inputs the destination data at step 104 while step 106 determines if the data constitutes intersection data. If so, step 106 proceeds to step 108.

A keyword list is then generated at step 110 in the same fashion previously described with respect to FIG. 8. Step 110 then proceeds to step 112.

At step 112, the system determines if the area, e.g. a city name, has been identified in the user input at step 104. If so, step 112 branches to step 114 where the second cache 52 is filled with intersection data around the area specified by the user. Step 114 the proceeds to step 116. Conversely, if the user input did not specify the area, step 112 proceeds directly to step 116.

At step 116, the processor queries the second cache 52 to identify the target or destination. Step 116 then proceeds to step 118 which determines whether or not the destination intersection was identified. If so, step 118 proceeds to step 120 where the processor calculates the preferred route to the destination and displays that route on the display screen 28.

Conversely, if the intersection is not identified at step 118, step 118 instead branches to step 122 where the processor extends the entire area of the intersection search to the entire intersection database 42. The intersection database 42 is queried at step 124 and, following that query, step 124 proceeds to step 126.

At step 126 the processor determines if the intersection was found. If so, step 126 proceeds to output the data 120 on the display device 28 and then exits the routine at step 128. Otherwise, step 126 branches back to step 102 to reinitiate the search by prompting the user to repeat the entry of the destination intersection.

From the foregoing, it can be seen that the present invention provides a powerful navigation system for an automotive vehicle which not only enables the desired destination to be entered in terms of the intersection, but also provides for rapid identification of that destination as well as the preferred route to that destination. Although preferably, the desired destination is entered by voice and parsed by the system to identify the keywords, other forms of entry of the intersection information may alternatively be used without deviation from the spirit or scope of the invention.

Having described our invention, however, many modifications thereto will become apparent to those skilled in the art to which it pertains without deviation from the spirit of the invention as defined by the scope of the appended claims.

We claim:

1. A vehicle navigation system comprising:
a processor,
a map database,
an input device for entering a destination to said processor, said processor programmed to access said map database and calculate a preferred route to said destination based upon data contained in said map database,
a video display which displays the preferred route to the destination,
wherein said map database includes a road link database and an intersection database separate from said road link database.

2. The invention as defined in claim 1 wherein said input device comprises a voice recognition circuit.

3. The invention as defined in claim 1 wherein said input device comprises a key pad.

4. The invention as defined in claim 3 wherein said key pad is displayed on said display and said display comprises a touch screen.

5. The invention as defined in claim 1 and comprising a cache memory containing intersection data from said intersection database in a predefined area surrounding a home location for the navigation system.

6. The invention as defined in claim 5 wherein said intersection data in said cache memory is stored in persistent memory.

7. The invention as defined in claim 1 and comprising a cache memory containing intersection data from said intersection database in a predefined area surrounding a current location for the navigation system.

8. The invention as defined in claim 7 wherein said processor is programmed to update the intersection data in said second cache memory whenever the location of the navigation system changes by a distance greater than a preset threshold.

9. A method for route calculation in an automotive navigation system comprising the steps of:
inputting a destination to a processor contained in the navigation system,
said processor accessing a map database and calculating a preferred route to the destination based upon information contained in said map database,
displaying the preferred route on a display device,
wherein said map database contains a road link database and an intersection database separate from said road link database.

10. The invention as defined in claim 9 wherein said inputting step comprises the step of decoding a verbal destination by utilizing a voice recognition device.

11. The invention as defined in claim 9 wherein said inputting step comprises the step of inputting the destination using a key pad.

12. The invention as defined in claim 11 wherein said key pad comprises a touch screen on said display device.

13. The invention as defined in claim 9 and comprising the step of storing intersection data for a predetermined area surrounding a home location in a cache.

14. The invention as defined in claim 13 and comprising the step of storing data in said cache in persistent memory.

15. The invention as defined in claim 9 and comprising the step of storing intersection data for a predetermined area surrounding a current location of the navigation system in a cache.

16. The invention as defined in claim 15 and comprising the step of updating the data in the cache whenever the navigation system moves more than a threshold distance.
